(19) United States
(12) Patent Application Publication
(10) Pub. No.: US 2026/0074111 A1
(43) Pub. Date: Mar. 12, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Nayoung Kim, Suwon-si (KR); Hyunjun Hwang, Suwon-si (KR); Changsoo Jang, Suwon-si (KR); Suji Kang, Suwon-si (KR); Won Seok Jang, Suwon-si (KR); Jinkyung Park, Suwon-si (KR); Jungmin Kim, Suwon-si (KR); Hongseok Kim, Suwon-si (KR)

(73) Assignee: SAMSUNG ELECTRO-MECHANICS CO., LTD., Suwon-si (KR)

(21) Appl. No.: 19/051,064

(22) Filed: Feb. 11, 2025

(30) Foreign Application Priority Data
Sep. 9, 2024 (KR) 10-2024-0122556

(51) Int. Cl. H01G 4/008; H01G 4/30

(52) U.S. Cl. CPC H01G 4/0085; H01G 4/30

(57) ABSTRACT

A multilayer ceramic capacitor including a capacitor body including a dielectric layer and an internal electrode layer, and an external electrode disposed on an outer surface of the capacitor body, wherein the internal electrode layer includes nickel (Ni), aluminum (Al), and silicon (Si), and an Al/Si weight ratio is about 0.01 to about 1.

### CROSS-REFERENCE TO RELATED APPLICATION

This application claims priority to and the benefit of Korean Patent Application No. 10-2024-0122556 filed in the Korean Intellectual Property Office on Sep. 9, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

In order to implement high-capacitance and small-sized MLCCs, the dielectric and internal electrodes should be thin. However, as the dielectric and internal electrodes become thinner, reliability problems such as shorts and breakdown voltage (BDV) deterioration also occur. Meanwhile, MLCCs used in autonomous vehicles, electric vehicles, etc. require high reliability.

### SUMMARY

An embodiment provides a multilayer ceramic capacitor having improved internal electrode connectivity and excellent high capacitance and reliability.

Another embodiment provides a method of manufacturing a multilayer ceramic capacitor.

An embodiment provides a multilayer ceramic capacitor including a capacitor body including a dielectric layer and an internal electrode layer, and an external electrode disposed on an outer surface of the capacitor body, wherein the internal electrode layer includes nickel (Ni), aluminum (Al), and silicon (Si), and an Al/Si weight ratio in the internal electrode layer is about 0.01 to about 1.

The internal electrode layer may include aluminum (Al) in an amount of about 0.01 part by weight to about 1 part by weight based on 100 parts by weight of nickel (Ni).

The internal electrode layer may include silicon (Si) in an amount of about 0.01 to about 8 parts by weight based on 100 parts by weight of nickel (Ni).

The internal electrode layer may further include one or more selected from tin (Sn), barium (Ba), titanium (Ti), and dysprosium (Dy).

The internal electrode layer may further include an internal electrode layer interface region defined as a region from an interface of the dielectric layer and the internal electrode layer to a depth of 100 nm into the internal electrode layer.

The internal electrode layer interface region may include a secondary phase including aluminum (Al), silicon (Si), and barium (Ba).

The dielectric layer may include a barium titanate-based compound including barium (Ba) and titanium (Ti).

The dielectric layer may further include aluminum (Al) and silicon (Si).

The dielectric layer may include aluminum (Al) in an amount of about 0.05 parts by mole to about 10 parts by mole based on 100 parts by mole of barium (Ba).

The dielectric layer may include silicon (Si) in an amount of about 0.05 parts by mole to about 10 parts by mole based on 100 parts by mole of barium (Ba).

The dielectric layer may further include a dielectric layer interface region defined as a region from an interface of the dielectric layer and the internal electrode layer to a depth of 100 nm into the dielectric layer.

The dielectric layer interface region may include a secondary phase including aluminum (Al), silicon (Si), and barium (Ba).

The dielectric layer may include a plurality of dielectric grains and grain boundaries disposed between the plurality of adjacent dielectric grains.

The grain boundaries may include secondary phases including aluminum (Al), silicon (Si), and barium (Ba).

Another embodiment provides a method of manufacturing a multilayer ceramic capacitor, including mixing nickel (Ni) and an aluminum (Al)-containing compound to prepare a conductive paste; manufacturing a dielectric green sheet from a dielectric slurry, and applying the conductive paste on a surface of the dielectric green sheet to form a conductive paste layer; manufacturing a dielectric green sheet stack by stacking a plurality of the dielectric green sheet on which the conductive paste layer is formed; manufacturing a capacitor body including a dielectric layer and an internal electrode layer by firing the dielectric green sheet stack; and forming an external electrode on an outer surface of the capacitor body, wherein at least one selected from the conductive paste and the dielectric slurry includes a silicon (Si)-containing compound, the internal electrode layer includes nickel (Ni), aluminum (Al), and silicon (Si), the aluminum (Al)-containing compound and the silicon (Si)-containing compound are included in a content ratio such that an Al/Si weight ratio in the internal electrode layer is about 0.01 to about 1.

The conductive paste may further include a tin (Sn)-containing compound.

The dielectric slurry may include a barium titanate-based compound.

The dielectric slurry may further include a dysprosium (Dy)-containing compound.

The conductive paste may include the silicon (Si)-containing compound, the silicon (Si)-containing compound may include SiO₂, and the aluminum (Al)-containing compound may include Al₂O₃.

Another embodiment provides a multilayer ceramic capacitor including a capacitor body including a dielectric layer and an internal electrode layer, and an external electrode disposed on an outer surface of the capacitor body, wherein the internal electrode layer includes aluminum (Al), and silicon (Si), and an Al/Si weight ratio in the internal electrode layer is about 0.01 to about 1.

The internal electrode layer may further include nickel (Ni), the internal electrode layer may include aluminum (Al) in an amount of about 0.01 part by weight to about 1 part by weight based on 100 parts by weight of nickel (Ni), and the internal electrode layer may include silicon (Si) in an amount of about 0.01 to about 8 parts by weight based on 100 parts by weight of nickel (Ni).

The dielectric layer may include a barium titanate-based compound including barium (Ba) and titanium (Ti), the dielectric layer may include aluminum (Al) in an amount of about 0.05 parts by mole to about 10 parts by mole based on 100 parts by mole of barium (Ba), the dielectric layer may include silicon (Si) in an amount of about 0.05 parts by mole to about 10 parts by mole based on 100 parts by mole of barium (Ba), the dielectric layer may include a dielectric layer interface region defined as a region from an interface of the dielectric layer and the internal electrode layer to a depth of 100 nm into the dielectric layer, and the dielectric layer interface region may include a secondary phase including aluminum (Al), silicon (Si), and barium (Ba).

The multilayer ceramic capacitor according to an embodiment of the present application not only has excellent thermal stability of internal electrode layers, but also has improved connectivity of internal electrode layers while being thin, and can have high capacitance and high reliability.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 is a graph showing thermomechanical analysis (TMA) curves for the case of Ni alone and the case of a mixture of Ni and Al₂O₃.

FIG. 6A is a TEM-EDS (transmission electron microscopy-energy dispersive spectroscopy) micrograph for an internal electrode layer according to Example 1. FIGS. 6B to 6D are each a TEM-EDS mapping analysis diagram for the internal electrode layer according to Example 1.

FIG. 7A is a TEM-EDS (transmission electron microscopy-energy dispersive spectroscopy) micrograph for a dielectric layer according to Example 1. FIGS. 7B to 7D are each a TEM-EDS mapping analysis diagram for the dielectric layer according to Example 1.

FIG. 8A is a TEM-EDS (transmission electron microscope-energy dispersive spectroscopy) micrograph for an internal electrode layer according to Example 1. FIG. 8B is a TEM-EDS point analysis diagram for the internal electrode layer according to Example 1.

FIG. 9A is a TEM-EDS (transmission electron microscope-energy dispersive spectroscopy) micrograph for an internal electrode layer according to Example 2. FIG. 9B is a TEM-EDS point analysis diagram for the internal electrode layer according to Example 2.

FIG. 10A is a TEM-EDS (transmission electron microscope-energy dispersive spectroscopy) micrograph for an internal electrode layer according to Example 3. FIG. 10B is a TEM-EDS point analysis diagram for the internal electrode layer according to Example 3.

FIG. 11A is a TEM-EDS (transmission electron microscope-energy dispersive spectroscopy) micrograph for an internal electrode layer according to Comparative Example 2. FIG. 11B is a TEM-EDS point analysis diagram for the internal electrode layer according to Comparative Example 2.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

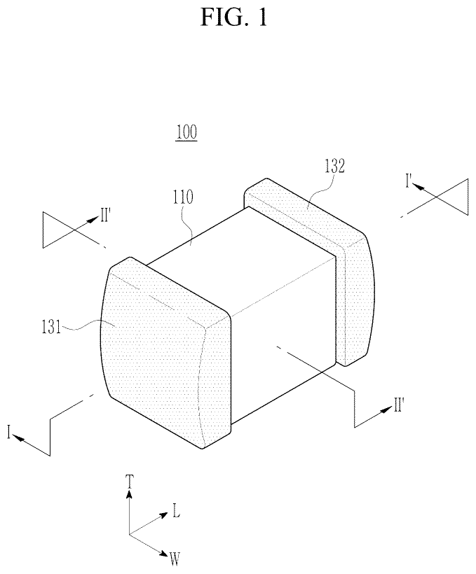

Hereinafter, a multilayer ceramic capacitor according to an embodiment will be described with reference to FIGS. 1 to 4.

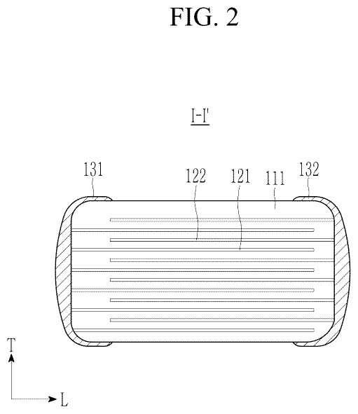

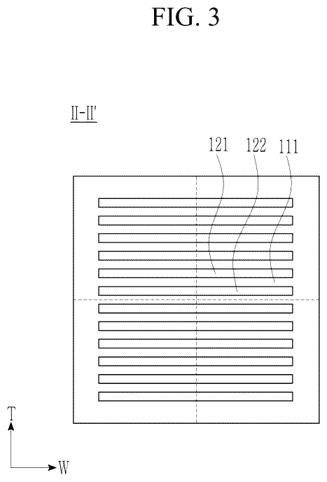

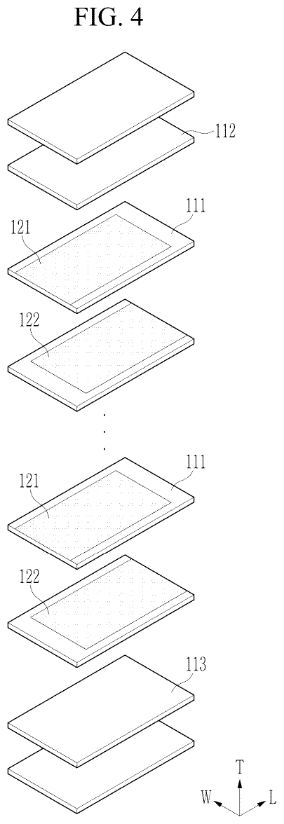

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outside the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region 120 in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the first internal electrode layer 121 and the second internal electrode layer 122 due to physical or chemical stress.

The internal electrode layers 121 and 122, i.e., the first internal electrode layer 121 and the second internal electrode layer 122, are electrodes having different polarities and are alternately arranged to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 according to an embodiment may include nickel (Ni), aluminum (Al), and silicon (Si).

In general, atomization of the material is required to implement a thin internal electrode layer. As the particle size of a material decreases, its melting point tends to decrease. The lowering of the melting point leads to a decrease in the onset temperature of heat shrinkage. Since the melting point of metal, which is the material of the internal electrode layer, is lowered to a greater extent than that of ceramic, which is the material of the dielectric layer, thinning of the internal electrode layer results in further increasing the sintering mismatch between the internal electrode layer and the dielectric layer during the firing process of the multilayer ceramic capacitor. For example, at the point where the sintering mismatch is maximized, the sintering points of the dielectric layer and the internal electrode layer may differ by more than about 500° C. As the internal electrode layer begins to sinter before the dielectric layer, nearby particles may agglomerate and balling may occur, and in areas printed with thin thickness, disconnection may occur first, and the connectivity of the internal electrode layer may deteriorate.

To solve these problems, a method of adding a co-material such as barium titanate to the internal electrode layer is being utilized. However, if the amount of the co-material added increases, the film density of the internal electrode layer may decrease, and the co-material may be squeezed out toward the dielectric layer, which may have the side effect of increasing the thickness of the dielectric layer.

According to an embodiment, since the internal electrode layers 121 and 122 include aluminum (Al) and silicon (Si) together with nickel (Ni), the thermal stability is excellent, so that even if the internal electrode layers are thinned, the connectivity of the internal electrode layers is improved, and accordingly, a multilayer ceramic capacitor with high capacitance and high reliability can be secured.

Nickel (Ni) may be the main component forming the internal electrode layers 121 and 122.

Aluminum (Al) can be derived from a raw material added as a subcomponent when forming the internal electrode layers 121 and 122. For example, the raw material may be an oxide, nitride, a salt compound of Al, or a compound in the form of a sol dispersed in an organic solvent.

Aluminum (Al) may be a non-reducing substance. Accordingly, the sintering delay effect is large and it can penetrate into the dielectric layer during firing. Al diffused into the dielectric layer can contribute to improving sintering mismatch, thereby improving the connectivity of the internal electrode layers even when the internal electrode layers are thinned.

Silicon (Si) may be derived from a raw material added as a co-material when forming the internal electrode layers 121 and 122, or may be derived from a raw material added as a subcomponent when forming the dielectric layer 111. For example, the raw material can be an oxide, nitride, salt compound of Si, or a compound in the form of a sol dispersed in an organic solvent.

In the internal electrode layers 121 and 122, a content ratio of aluminum (Al) and silicon (Si), i.e., a weight ratio of Al to Si, Al/Si weight ratio, may be about 0.01 to about 1, for example, about 0.02 to about 0.9, about 0.03 to about 0.8, about 0.04 to about 0.7, or about 0.05 to about 0.6. When the Al/Si weight ratio in the internal electrode layer is within the above range, the connectivity of the internal electrode layer is improved, and thus the multilayer ceramic capacitor according to an embodiment can have high capacitance and high reliability.

Specifically, in the internal electrode layers 121 and 122, aluminum (Al) may be included in an amount of about 0.01 part by weight to about 1 part by weight, for example, about 0.05 part by weight to about 0.95 part by weight, about 0.1 part by weight to about 0.9 part by weight, about 0.15 part by weight to about 0.85 part by weight, or about 0.2 part by weight to about 0.8 part by weight based on 100 parts by weight of nickel (Ni). When the content of aluminum (Al) in the internal electrode layer is within the above range, the connectivity of the internal electrode layer is improved, so that the multilayer ceramic capacitor according to an embodiment can have high capacitance and high reliability.

In the internal electrode layers 121 and 122, silicon (Si) may be included in an amount of about 0.01 parts by weight to about 8 parts by weight, for example, about 0.05 parts by weight to about 7.5 parts by weight, about 0.1 parts by weight to about 7 parts by weight, about 0.15 parts by weight to about 6.5 parts by weight, or about 0.2 parts by weight to about 6 parts by weight based on 100 parts by weight of nickel (Ni). When the content of silicon (Si) in the internal electrode layer is within the above range, the connectivity of the internal electrode layer is improved, so that the multilayer ceramic capacitor according to an embodiment can have high capacitance and high reliability.

In addition to the aforementioned elements, the internal electrode layers 121 and 122 may further include one or more elements selected from tin (Sn), barium (Ba), titanium (Ti), and dysprosium (Dy).

The elements and element contents included in the internal electrode layers 121 and 122 can be confirmed through TEM-EDS (transmission electron microscope-energy dispersive spectroscopy) analysis.

In more detail, after the multilayer ceramic capacitor 100 was placed into the epoxy mixture liquid and then cured, the L-axis and the T-axis directional surface (LT surface) of the capacitor body 110 was polished to ½ depth in the W-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample can be measured using a transmission electron microscope (TEM) so that at least one layer of the dielectric layer and the internal electrode layer are visible, for example, one to six layers. For example, TEM can be measured under conditions of an acceleration voltage of 200 kV using a Xe-FIB (focused ion beam) in an area of about 800 nm×800 nm in which at least one dielectric layer and one internal electrode layer are visible in the active region. Next, by performing EDS (energy dispersive spectroscopy) point analysis on the internal electrode layer through the TEM image of the measured cross-sectional sample, the presence and content of elements such as Ni, Al, and Si in the internal electrode layers 121 and 122 can be confirmed. For example, the contents of Al and Si and the Al/Si weight ratio according to an embodiment can be obtained by dividing the active region of the cross-sectional sample into three equal parts, upper, middle, and lower, during the EDS point analysis, by taking three points within the internal electrode layer for each area and taking the average value from a total of nine points. Other methods and/or tools appreciated by one of ordinary skill in the art, even if not described in the present disclosure, may also be used.

The internal electrode layers 121 and 122 may further include a metal such as Cu, Ag, Pd, or Au, or an alloy thereof, in addition to Ni, which is included as a main component.

Additionally, the internal electrode layers 121 and 122 may include dielectric particles having the same composition as the ceramic material included in the dielectric layer 111.

The internal electrode layers 121 and 122 may further include an internal electrode layer interface region defined as a region from the interface of the dielectric layer 111 and the internal electrode layers 121 and 122 to a depth of 100 nm in the direction of the internal electrode layer. The internal electrode layer interface region may be observed with TEM. Other methods and/or tools appreciated by one of ordinary skill in the art, even if not described in the present disclosure, may also be used.

The internal electrode layer interface region may include a secondary phase including aluminum (Al), silicon (Si), and barium (Ba).

The secondary phase may refer to a new phase precipitated after the dielectric green sheet laminate is sintered. Al, Si, and Ba included in the secondary phase can each be chemically combined and exist in the form of a compound.

During the manufacturing of a multilayer ceramic capacitor, aluminum (Al) and silicon (Si) diffuse from the internal electrode layer to the dielectric layer during firing, forming a secondary phase of a glass component including Al, Si, and Ba, which can promote grain growth of the dielectric. When a secondary phase is included in the interface between the dielectric layer and the internal electrode layer, specifically, in the interface region of the internal electrode layer, the firing temperature of the dielectric is reduced, diffusion of additive components such as Dy is promoted, and a core-shell structure of dielectric crystal grains can be formed. Accordingly, the connectivity of the internal electrode layers is improved, and the capacitance characteristics and reliability of the multilayer ceramic capacitor can be improved.

An average thickness of the internal electrode layers 121 and 122 may be about 0.1 μm to about 2 μm. When the average thickness of the internal electrode layers 121 and 122 is within the above range, the reliability of the multilayer ceramic capacitor is excellent.

The average thickness of the internal electrode layers 121 and 122 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers 111. In a scanning electron microscope (SEM) image of a measured cross-sectional sample, the central point in the length direction (L-axis direction) or the width direction (W-axis direction) of the first internal electrode layer 121 or the second internal electrode layer 122 is used as a reference point, and the arithmetic mean value of the thickness of the first internal electrode layer 121 or the second internal electrode layer 122 at 10 points spaced apart from the reference point by a predetermined interval can be obtained. The spacing between the 10 points can be adjusted according to the scale of the scanning electron microscope (SEM) image, and can be, for example, about 1 μm to about 100 μm, about 1 μm to about 50 μm, or about 1 μm to about 10 μm. At this time, all 10 points should be located within the first internal electrode layer 121 or the second internal electrode layer 122, and if all 10 points are not located within the first internal electrode layer 121 or the second internal electrode layer 122, the location of the reference point can be changed or the interval between the 10 points can be adjusted.

According to an embodiment, the dielectric layer 111 may include a barium titanate-based compound including barium (Ba) and titanium (Ti) as a main component.

The barium titanate-based compound is a dielectric base material, have high permittivity, and contribute to forming the permittivity of multilayer ceramic capacitors 100.

For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃ and (Ba, Sr)(Ti, Sn)O₃.

The dielectric layer 111 may further include aluminum (Al) and silicon (Si).

The aluminum (Al) in the dielectric layer 111 may be derived from a raw material added as a subcomponent when forming the internal electrode layers 121 and 122. The aluminum (Al) can diffuse from the internal electrode layer to the dielectric layer during sintering, thereby improving sintering mismatch.

In the dielectric layer 111, the aluminum (Al) may be included in an amount of about 0.05 parts by mole to about 10 parts by mole, for example, about 0.1 parts by mole to about 9 parts by mole, about 0.15 parts by mole to about 8 parts by mole, or about 0.2 parts by mole to about 7 parts by mole based on 100 parts by mole of barium (Ba). When the content of aluminum (Al) in the dielectric layer is within the above range, the firing temperature of the dielectric can be reduced and the diffusion of additive components such as dysprosium (Dy) can be promoted. Accordingly, the connectivity of the internal electrode layers is improved, and a multilayer ceramic capacitor with high capacitance and high reliability can be secured.

Silicon (Si) in the dielectric layer 111 can be derived from a raw material added as a co-material when forming the internal electrode layers 121 and 122. That is, silicon (Si) can also diffuse from the internal electrode layer to the dielectric layer during firing. Additionally, silicon (Si) in the dielectric layer 111 may be derived from a raw material added as a subcomponent during formation of the dielectric layer 111.

In the dielectric layer 111, silicon (Si) may be included in an amount of about 0.05 parts by mole to about 10 parts by mole, for example, about 0.1 parts by mole to about 9 parts by mole, about 0.15 parts by mole to about 8 parts by mole, or about 0.2 parts by mole to about 7 parts by mole based on 100 mol parts of barium (Ba). When the content of silicon (Si) in the dielectric layer is within the above range, the firing temperature of the dielectric can be reduced during the manufacture of a multilayer ceramic capacitor, and the diffusion of additive components such as dysprosium (Dy) can be promoted. Accordingly, the connectivity of the internal electrode layers is improved, and a multilayer ceramic capacitor with high capacitance and high reliability can be secured.

The dielectric layer 111 may further include at least one selected from nickel (Ni) and dysprosium (Dy).

The dielectric layer 111 may further include a dielectric layer interface region defined as a region from the interface of the dielectric layer 111 and the internal electrode layers 121 and 122 to a depth of 100 nm in the direction of the dielectric layer. The dielectric layer interface region may be observed with TEM. Other methods and/or tools appreciated by one of ordinary skill in the art, even if not described in the present disclosure, may also be used.

The dielectric layer interface region may include a secondary phase comprising aluminum (Al), silicon (Si), and barium (Ba). During the manufacturing of a multilayer ceramic capacitor, aluminum (Al) and silicon (Si) can diffuse from the internal electrode layer to the dielectric layer during firing to form a secondary phase of a glass component including Al, Si, and Ba. When a secondary phase is included in the interface between the dielectric layer and the internal electrode layer, specifically in the dielectric layer interface region, the firing temperature is reduced and diffusion of additive components such as Dy can be promoted. Accordingly, the connectivity of the internal electrode layers is improved, and the capacitance characteristics and reliability of the multilayer ceramic capacitor can be improved.

The dielectric layer 111 may include a plurality of dielectric grains and grain boundaries arranged between a plurality of adjacent dielectric grains. The grain boundaries may include secondary phases including aluminum (Al), silicon (Si), and barium (Ba). During the manufacturing of a multilayer ceramic capacitor, aluminum (Al) and silicon (Si) can diffuse from the internal electrode layer to the dielectric layer during firing to form a secondary phase of a glass component including Al, Si, and Ba. When a secondary phase is included in the grain boundary, the firing temperature is reduced and diffusion of additive components such as Dy can be promoted. Accordingly, the connectivity of the internal electrode layers is improved, and the capacitance characteristics and reliability of the multilayer ceramic capacitor can be improved.

The elements and element contents included in the dielectric layer 111 can be confirmed by the same method as the TEM-EDS analysis for the internal electrode layers 121 and 122 described above. That is, by performing EDS (energy dispersive spectroscopy) point analysis on the dielectric layer through the TEM image of the cross-sectional sample measured by the above-described method, the presence and content of elements such as Ba, Ti, Al, and Si in the dielectric layer 111 can be confirmed. For example, the contents of Al and Si present in the dielectric layer can be obtained by dividing the active region of the cross-sectional sample into three parts, upper, middle, and lower, during the EDS point analysis, taking three points within the dielectric layer for each area and taking the average value from a total of nine points. Other methods and/or tools appreciated by one of ordinary skill in the art, even if not described in the present disclosure, may also be used.

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor is excellent.

This can be obtained by taking the central point in the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted.

The capacitor body 110 may be formed by firing a stacking structure in which the plurality of dielectric layers 111 and internal electrode layers 121 and 122 are stacked.

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and an alloy thereof, for example, copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

Hereinafter, a method of manufacturing the multilayer ceramic capacitor 100 according to an embodiment will be described.

The multilayer ceramic capacitor 100 according to an embodiment may be manufactured by preparing a conductive paste; manufacturing a dielectric green sheet using a dielectric slurry, and printing the conductive paste on a surface of the dielectric green sheet to form a conductive paste layer; manufacturing a dielectric green sheet stack by stacking the dielectric green sheet on which the conductive paste layer is formed; manufacturing a capacitor body including a dielectric layer and an internal electrode layer by firing the dielectric green sheet stack; and forming an external electrode on an outer surface of the capacitor body.

The conductive paste may be prepared by mixing nickel (Ni) and aluminum (Al)-containing compounds, and optionally, a silicon (Si)-containing compound may be further mixed.

For example, the melting point of barium titanate (BaTiO₃) may be 1625° C., the melting point of aluminum oxide (Al₂O₃) may be 2072° C., and the melting point of nickel oxide (NiO) may be 1455° C. That is, when an aluminum (Al)-containing compound is mixed into the conductive paste, the melting point is higher than that of barium titanate, which is conventionally used as a co-material when forming internal electrodes, and thus the thermal stability is excellent, so that the sintering mismatch is improved, thereby improving the connectivity of the internal electrode layer.

The conductive paste may further contain a tin (Sn)-containing compound.

In addition to nickel (Ni), the conductive paste may be prepared by further mixing one or more conductive metals selected from copper (Cu), silver (Ag), palladium (Pd), gold (Au), and an alloy thereof.

Additionally, the conductive paste may be prepared by additionally mixing a binder and a solvent. Additionally, barium titanate powder may be mixed in as a co-material if necessary. The co-material may act to suppress sintering of the conductive powder during the firing process.

A dielectric slurry may be prepared by mixing a barium titanate-based compound as a main component powder and optionally a subcomponent powder. The secondary powder may include, for example, a dysprosium (Dy)-containing compound. The subcomponent powder may optionally further include a silicon (Si)-containing compound.

The silicon (Si)-containing compound may be included in at least one of the conductive paste and the dielectric slurry.

The aluminum (Al)-containing compound and the silicon (Si)-containing compound may be introduced in the internal electrode layers 121 and 122 at a content ratio such that the Al/Si weight ratio is about 0.01 to about 1, and for example, may be introduced at a content ratio such that the Al/Si weight ratio is about 0.02 to about 0.9, about 0.03 to about 0.8, about 0.04 to about 0.7, or about 0.05 to about 0.6. When the aluminum (Al)-containing compound and the silicon (Si)-containing compound are added in the above content ratio range, a multilayer ceramic capacitor having high capacitance and high reliability can be obtained as the connectivity of the internal electrode layers is improved.

The aluminum (Al)-containing compound, silicon (Si)-containing compound, tin (Sn)-containing compound and dysprosium (Dy)-containing compound may be, for example, an oxide, a nitride, a salt compound of Al, Si, Sn and Dy, respectively, or a compound in the form of a sol dispersed in an organic solvent.

The dielectric slurry may be prepared by additionally mixing additives such as a dispersant, a binder, a plasticizer, a lubricant, an antistatic agent, and a solvent.

The dispersant may include at least one selected from, for example, a phosphoric acid ester-based dispersant and a polycarboxylic acid-based dispersant. The dispersant may be mixed in an amount of about 0.1 part by weight to about 5 parts by weight, for example, about 0.3 parts by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

In the step of manufacturing the dielectric green sheet, a dielectric slurry may be prepared by mixing a barium titanate-based compound as a main component powder and optionally a subcomponent powder.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 3

A conductive paste was prepared by mixing nickel (Ni), aluminum oxide (Al₂O₃), and silicon dioxide (SiO₂). Herein, Al₂O₃ and SiO₂ were mixed to have an Al/Si weight ratio of 0.1, 0.5, and 1, respectively in a final internal electrode layer, as shown in Table 1,

Subsequently, barium titanate (BaTiO₃) powder was used to prepare dielectric slurry. Herein, the dielectric slurry was prepared by adding ethanol/toluene, a dispersant, and a binder thereto and mechanically milling them with zirconia balls (ZrO₂ ball) as a dispersive medium.

Subsequently, the prepared dielectric slurry was used to manufacture a dielectric green sheet by using a head discharge type on-roll forming coater. The dielectric green sheet on which the conductive paste layer was formed were stacked and pressed to manufacture a dielectric green sheet stack.

The dielectric green sheet stack was manufactured by stacking and pressing dielectric green sheets having a conductive paste layer formed thereon.

The dielectric green sheet stack was calcinated at 400° C. or less under a nitrogen atmosphere and fired at 1300° C. or less at a hydrogen (H₂) concentration of 1.0% or less.

Subsequently, the dielectric green sheet stack was used to manufacture a multilayer ceramic capacitor through processes of forming an external electrode, plating, or the like.

### Comparative Example 1

A multilayer ceramic capacitor was manufactured in the same manner as in Example 1 except that the conductive paste was prepared by mixing Ni and SiO₂. Herein, SiO₂ was used to have 0.05 parts by weight of Si based on 100 parts by weight of Ni in the internal electrode layer.

### Comparative Example 2

A multilayer ceramic capacitor was manufactured in the same manner as in Example 1 except that Al₂O₃ and SiO₂ were used to have an Al/Si weight ratio of 3 in the final internal electrode layer, as shown in Table 1.

TABLE 1

| | Al/Si weight ratio |
|---|---|
| Example 1 | 0.064 |
| Example 2 | 0.357 |
| Example 3 | 0.56 |
| Comparative Example 1 | 0 |
| Comparative Example 2 | 3 |

### Evaluation 1: TMA Analysis

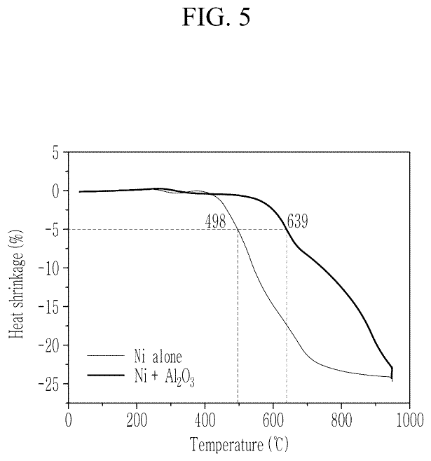

A thermomechanical analysis (TMA) was performed for a case of using Ni alone and another case of using a mixture of Ni and Al₂O₃, and the results are shown in FIG. 5.

The TMA measurement was performed under conditions of 3% H₂ and a heating rate of 10 K/min.

FIG. 5 is a graph showing thermomechanical analysis (TMA) curves for the case of Ni alone and the case of the mixture of Ni and Al₂O₃. Referring to FIG. 5, a temperature at which Ni powder shrinks by 5% may be obtained. In the case of using Ni alone, Ni powder shrank at 498° C., but in the case of using the mixture Ni and Al₂O₃, shrinkage was observed at 639° C., which indicated a shrinkage delay by 141° C. Accordingly, when Al₂O₃ was added to form an internal electrode layer, there was a thermal shrinkage delay effect.

### Evaluation 2: TEM-EDS Mapping Analysis

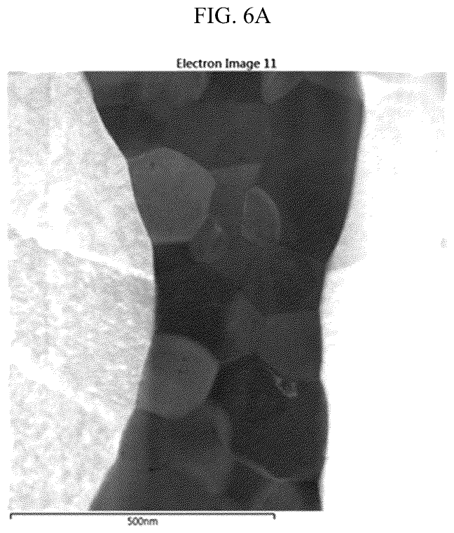

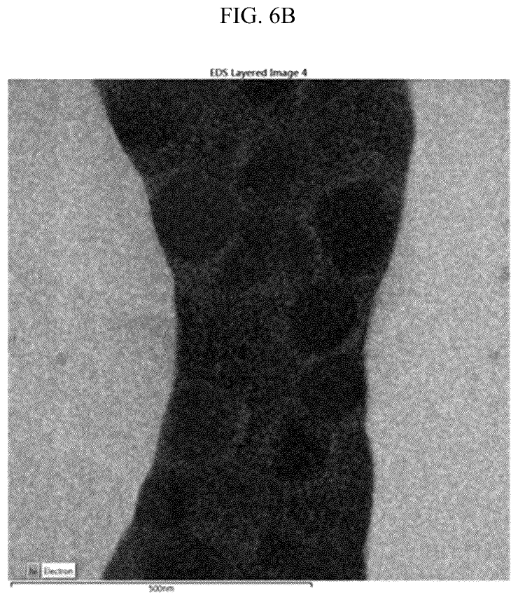

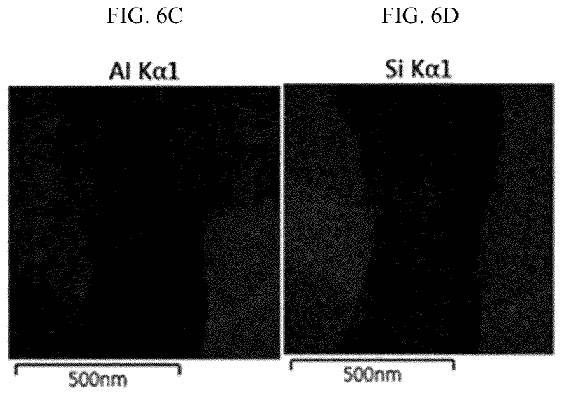

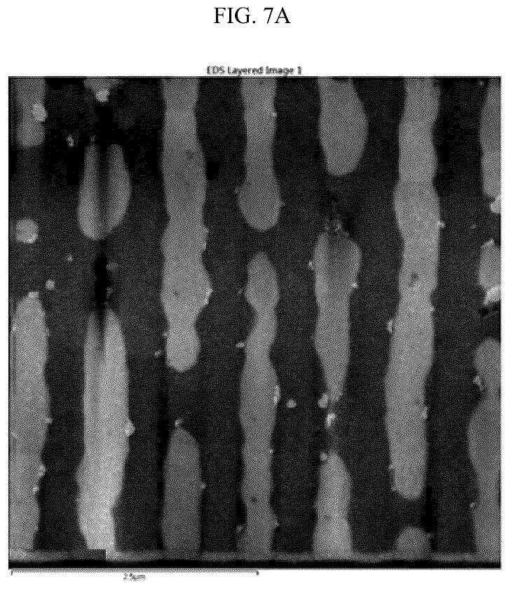

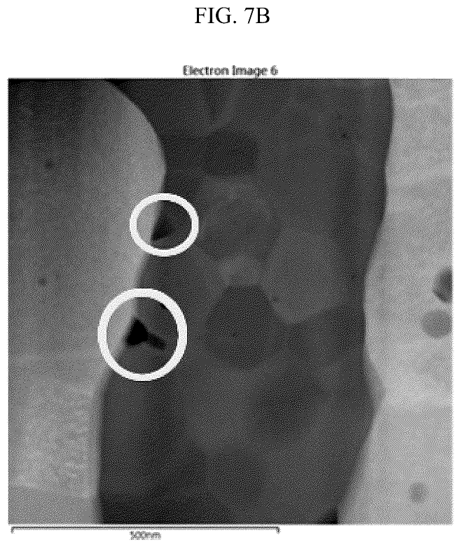

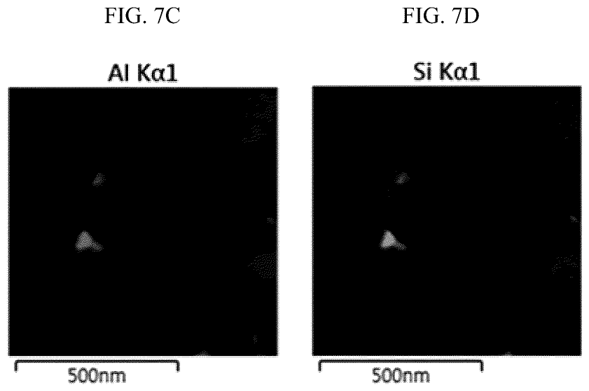

The multilayer ceramic capacitor of Example 1 was subjected to TEM-EDS (transmission electron microscopy-energy dispersive spectroscopy) mapping analysis, and the results are shown in FIGS. 6A to 7D.

Specifically, the multilayer ceramic capacitors manufactured in Example 1 were placed into an epoxy mixture liquid and cured, and after polishing the L-axis and T-axis direction surface (LT surface) of each capacitor body to a depth of ½ in the W-axis direction, the capacitor body was fixed and maintained in a vacuum atmosphere chamber to obtain a cross-sectional sample for observing an active region where a dielectric layer and an internal electrode layer crossed each other. Subsequently, the active region of the cross-sectional sample was measured with a transmission electron microscope (TEM) to ensure that at least one dielectric layer and internal electrode layer were respectively visible. The TEM measurement was performed under conditions of an accelerating voltage of 200 kV by using an Xe-FIB (focused ion beam) over an area of about 800 nm×800 nm in the active region where at least one dielectric layer and internal electrode layer were respectively visible. Subsequently, the TEM image of the cross-sectional sample was subjected to EDS (energy dispersive spectroscopy) mapping analysis.

FIG. 6A is a TEM-EDS (transmission electron microscopy-energy dispersive spectroscopy) micrograph for an internal electrode layer according to Example 1. FIGS. 6B to 6D are each a TEM-EDS mapping analysis diagram for the internal electrode layer according to Example 1.

Referring to FIGS. 6A to 6D, Ni, Al, and Si were confirmed to be present in the internal electrode layer of Example 1.

FIG. 7A is a TEM-EDS (transmission electron microscopy-energy dispersive spectroscopy) micrograph for a dielectric layer according to Example 1. FIGS. 7B to 7D are each a TEM-EDS mapping analysis diagram for the dielectric layer according to Example 1.

Referring to FIGS. 7A to 7D, a secondary phase including Al, Si, and Ba was confirmed to be formed in the interface region of the dielectric layer in Example 1.

### Evaluation 3: TEM-EDS Point Analysis

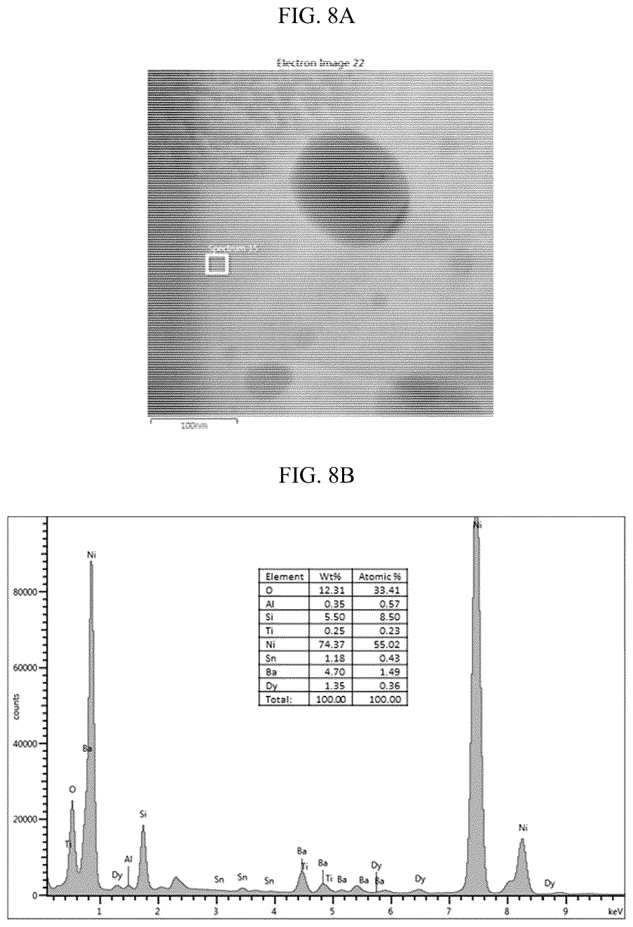

The multilayer ceramic capacitors according to Examples 1 to 3, and Comparative Examples 1 and 2 were subjected to TEM-EDS (transmission electron microscopy-energy dispersive spectroscopy) point analysis, and the results are shown in FIGS. 8A to 11B.

The cross-sectional sample analyzed in Evaluation 2 was used for EDS (energy dispersive spectroscopy) point analysis of the internal electrode layer and an Al/Si weight ratio in the internal electrode layer was calculated. Specifically, when the active region of the cross-sectional sample was divided into three portions of upper, central, and lower portions, three points were taken in each portion in the internal electrode layer to obtain an Al/Si weight ratio at all the nine points in total, which were used to calculate an average Al/Si weight ratio.

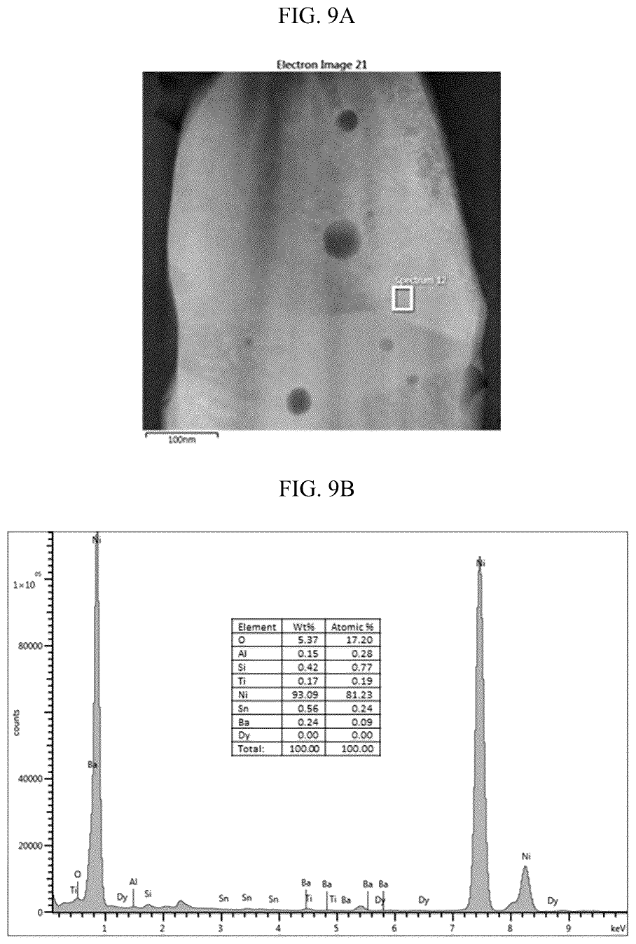

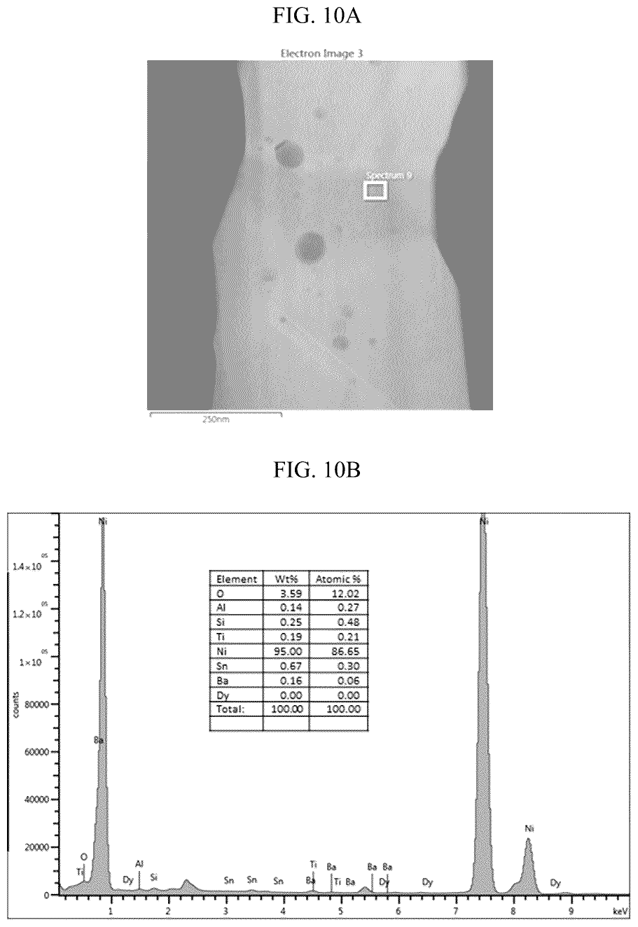

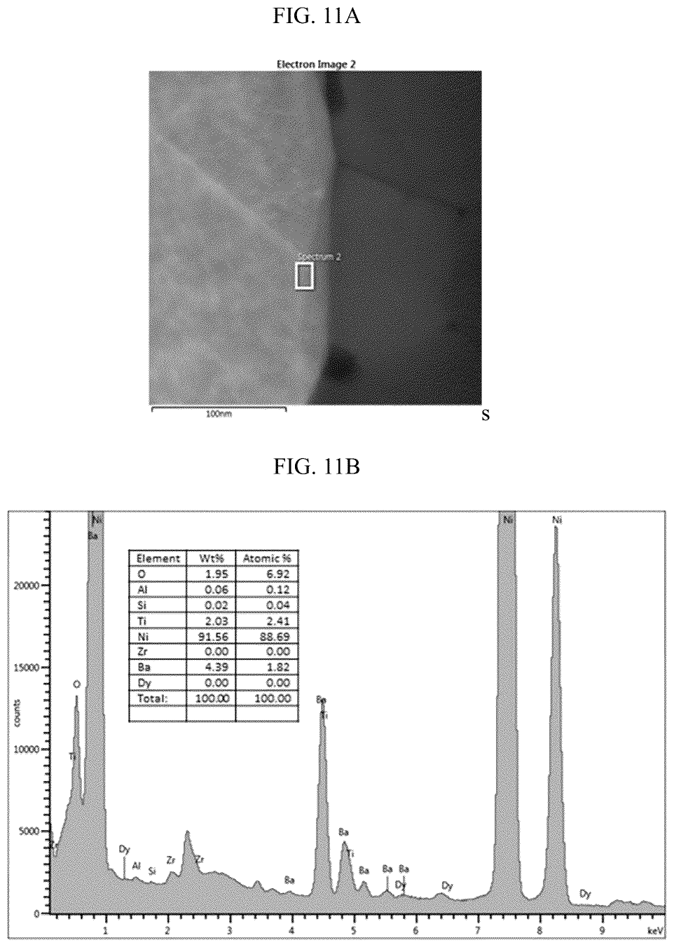

FIG. 8A is a TEM-EDS (transmission electron microscope-energy dispersive spectroscopy) micrograph for an internal electrode layer according to Example 1. FIG. 8B is a TEM-EDS point analysis diagram for the internal electrode layer according to Example 1. FIG. 9A is a TEM-EDS (transmission electron microscope-energy dispersive spectroscopy) micrograph for an internal electrode layer according to Example 2. FIG. 9B is a TEM-EDS point analysis diagram for the internal electrode layer according to Example 2. FIG. 10A is a TEM-EDS (transmission electron microscope-energy dispersive spectroscopy) micrograph for an internal electrode layer according to Example 3. FIG. 10B is a TEM-EDS point analysis diagram for the internal electrode layer according to Example 3. FIG. 11A is a TEM-EDS (transmission electron microscope-energy dispersive spectroscopy) micrograph for an internal electrode layer according to Comparative Example 2. FIG. 11B is a TEM-EDS point analysis diagram for the internal electrode layer according to Comparative Example 2.

Referring to FIGS. 8A to 10B, Ni, Al, and Si were confirmed to be present in the internal electrode layer in Examples 1 to 3, and the Al/Si weight ratio in these examples satisfied the range of 0.01 to 1. On the contrary, referring to FIGS. 11A and 11B, in Comparative Example 2, Ni, Al, and Si were present in the internal electrode layer, but the Al/Si weight ratio did not satisfy the predetermined range.

### Evaluation 4: MLCC Characteristics

### Evaluation 4-1: Connectivity of Internal Electrode Layer

The connectivity of the internal electrode layer in the multilayer ceramic capacitors according to Examples 1 to 3 and Comparative Examples 1 and 2 were measured as described in the following method, and the results are shown in Table 2.

A cross-sectional sample was obtained in the same manner as in Evaluation 2 and then, a scanning electron microscope (SEM) image of the sample was taken such that at least six dielectric layers and six internal electrode layers were visible in the center portion of the active region of the cross-sectional sample. The SEM measurement was taken at 10K magnifications under 10 kV conditions. In the obtained SEM image, the connectivity of the internal electrode layer was calculated from Equation 1.

$$Connectivity ( \% ) of internal electrode layer = ( sum of lengths of a plurality of internal electrode layers excluding disconnected portions / the sum of the length of the plurality of internal electrode layers ) \times 100 \qquad [ Equation 1 ]$$

### Evaluation 4-2: Thinning Index

The thinning index of the multilayer ceramic capacitors according to Examples 1 to 3 and Comparative Example 1 and 2 were measured according to the following method, and the results are shown in Table 2.

From the SEM image obtained in the same manner as in the aforementioned evaluation of the connectivity of the internal electrode layer, the thinning index was calculated from Equation 2.

$$Thinning index = \{ thickness ( nm ) of internal electrode layer / connectivity ( \% ) of internal electrode layer \} \times 100 \qquad [ Equation 2 ]$$

In Equation 2, a thickness of the internal electrode layer was an average thickness at 10 points in one internal electrode layer, and the connectivity of the internal electrode layer obtained from Equation 1 was used.

### Evaluation 4-3: Capacitance

The capacitance of the multilayer ceramic capacitors according to Examples 1 to 3 and Comparative Examples 1 and 2 were measured according to the following method, and the results are shown in Table 2.

The capacitance (F) was measured at a frequency of 1 kHz and a voltage of 0.5 V.

### Evaluation 4-4: Withstand Voltage Characteristics

The breakdown voltage (BDV) of the multilayer ceramic capacitors according to Examples 1 to 3 and Comparative Examples 1 and 2 were measured, and the results are shown in Table 2.

The breakdown voltage (BDV) was obtained by measuring a voltage at which the multilayer ceramic capacitors according to Examples 1 to 3 and Comparative Examples 1 and 2 had insulation resistance (IR) of 10000Ω or less at room temperature (25° C.) by increasing a voltage at 100 V/s.

### Evaluation 4-5: Reliability

The mean time to failure (MTTF) of the multilayer ceramic capacitors of Examples 1 to 3 and Comparative Examples 1 and 2 were measured according to the following method, and the results are shown in Table 2.

MTTF (mean time to failure) was obtained by measuring mean time (hr) to failure at a temperature of 125° C. for 48 hours at a voltage of 9.45 V.

In Table 2, connectivity, a thinning index, capacitance, BDV, and MTTF of each internal electrode layer were expressed as a ratio based on the results of Comparative Example 1.

TABLE 2

| | | Connectivity | | | | |
|---|---|---|---|---|---|---|
| | | of internal | | | | |
| | Al/Si weight | electrode | Thinning | | | |
| | ratio | layer | index | Capacitance | BDV | MTTF |
| Comparative | 0 | 1 | 1 | 1 | 1 | 1 |
| Example 1 | | (reference) | (reference) | (reference) | (reference) | (reference) |
| Comparative | 3 | 0.95 | 0.99 | 0.94 | 0.97 | 0.90 |
| Example 2 | | | | | | |
| Example 1 | 0.064 | 1.01 | 1.01 | 1.02 | 1.01 | 1.02 |
| Example 2 | 0.357 | 1.05 | 1.04 | 1.05 | 1.03 | 1.11 |
| Example 3 | 0.56 | 1.10 | 1.07 | 1.06 | 1.05 | 1.14 |

Referring to Table 2, the multilayer ceramic capacitors of Examples 1 to 3, compared with the multilayer ceramic capacitors of Comparative Examples 1 and 2, exhibited a combination of excellent connectivity, capacitance, and reliability of the internal electrode layer. Accordingly, the multilayer ceramic capacitor in which an Al/Si weight ratio in the internal electrode layer satisfied the predetermined range according to an embodiment exhibited improved thermal stability and connectivity of internal electrodes, high-capacitance, and high reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the internal electrode layer includes nickel (Ni), aluminum (Al), and silicon (Si), and
an Al/Si weight ratio in the internal electrode layer is 0.01 to 1.

2. The multilayer ceramic capacitor of claim 1, wherein
the internal electrode layer includes aluminum (Al) in an amount of 0.01 parts by weight to 1 part by weight based on 100 parts by weight of nickel (Ni).

3. The multilayer ceramic capacitor of claim 1, wherein
the internal electrode layer includes silicon (Si) in an amount of 0.01 parts by weight to 8 parts by weight based on 100 parts by weight of nickel (Ni).

4. The multilayer ceramic capacitor of claim 1, wherein
the internal electrode layer further includes one or more selected from tin (Sn), barium (Ba), titanium (Ti), and dysprosium (Dy).

5. The multilayer ceramic capacitor of claim 1, wherein
the internal electrode layer includes an internal electrode layer interface region defined as a region from an interface of the dielectric layer and the internal electrode layer to a depth of 100 nm into the internal electrode layer.

6. The multilayer ceramic capacitor of claim 5, wherein
the internal electrode layer interface region includes a secondary phase including aluminum (Al), silicon (Si), and barium (Ba).

7. The multilayer ceramic capacitor of claim 1, wherein
the dielectric layer includes a barium titanate-based compound including barium (Ba) and titanium (Ti).

8. The multilayer ceramic capacitor of claim 7, wherein
the dielectric layer further includes aluminum (Al) and silicon (Si).

9. The multilayer ceramic capacitor of claim 8, wherein
the dielectric layer includes aluminum (Al) in an amount of 0.05 parts by mole to 10 parts by mole based on 100 parts by mole of barium (Ba).

10. The multilayer ceramic capacitor of claim 8, wherein
the dielectric layer includes silicon (Si) in an amount of 0.05 parts by mole to 10 parts by mole based on 100 parts by mole of barium (Ba).

11. The multilayer ceramic capacitor of claim 1, wherein
the dielectric layer includes a dielectric layer interface region defined as a region from an interface of the dielectric layer and the internal electrode layer to a depth of 100 nm into the dielectric layer.

12. The multilayer ceramic capacitor of claim 11, wherein
the dielectric layer interface region includes a secondary phase including aluminum (Al), silicon (Si), and barium (Ba).

13. The multilayer ceramic capacitor of claim 1, wherein
the dielectric layer includes a plurality of dielectric grains and grain boundaries disposed between the plurality of the dielectric grains.

14. The multilayer ceramic capacitor of claim 13, wherein
the grain boundaries include secondary phases including aluminum (Al), silicon (Si), and barium (Ba).

15. A method of manufacturing a multilayer ceramic capacitor, comprising
mixing nickel (Ni) and an aluminum (Al)-containing compound to prepare a conductive paste;
manufacturing a dielectric green sheet from a dielectric slurry, and applying the conductive paste on a surface of the dielectric green sheet to form a conductive paste layer;
manufacturing a dielectric green sheet stack by stacking a plurality of the dielectric green sheet on which the conductive paste layer is formed;
manufacturing a capacitor body including a dielectric layer and an internal electrode layer by firing the dielectric green sheet stack; and
forming an external electrode on an outer surface of the capacitor body,
wherein at least one selected from the conductive paste and the dielectric slurry includes a silicon (Si)-containing compound,
the internal electrode layer includes nickel (Ni), aluminum (Al), and silicon (Si), and
the aluminum (Al)-containing compound and the silicon (Si)-containing compound are included in a content ratio such that an Al/Si weight ratio in the internal electrode layer is 0.01 to 1.

16. The method of claim 15, wherein
the conductive paste further includes a tin (Sn)-containing compound.

17. The method of claim 15, wherein
the dielectric slurry includes a barium titanate-based compound.

18. The method of claim 17, wherein
the dielectric slurry further includes a dysprosium (Dy)-containing compound.

19. The method of claim 15, wherein the conductive paste includes the silicon (Si)-containing compound,
wherein the silicon (Si)-containing compound includes SiO₂, and
wherein the aluminum (Al)-containing compound includes Al₂O₃.

20. A multilayer ceramic capacitor, comprising
a capacitor body including a dielectric layer and an internal electrode layer, and
an external electrode disposed on an outer surface of the capacitor body,
wherein the internal electrode layer includes aluminum (Al), and silicon (Si), and
an Al/Si weight ratio in the internal electrode layer is 0.01 to 1.

21. The multilayer ceramic capacitor of claim 20, wherein
the internal electrode layer further includes nickel (Ni),
the internal electrode layer includes aluminum (Al) in an amount of 0.01 parts by weight to 1 part by weight based on 100 parts by weight of nickel (Ni), and
the internal electrode layer includes silicon (Si) in an amount of 0.01 parts by weight to 8 parts by weight based on 100 parts by weight of nickel (Ni).

22. The multilayer ceramic capacitor of claim 21, wherein
the dielectric layer includes a barium titanate-based compound including barium (Ba) and titanium (Ti),
the dielectric layer includes aluminum (Al) in an amount of 0.05 parts by mole to 10 parts by mole based on 100 parts by mole of barium (Ba),
the dielectric layer includes silicon (Si) in an amount of 0.05 parts by mole to 10 parts by mole based on 100 parts by mole of barium (Ba),
the dielectric layer comprises a dielectric layer interface region defined as a region from an interface of the dielectric layer and the internal electrode layer to a depth of 100 nm into the dielectric layer, and
the dielectric layer interface region includes a secondary phase including aluminum (Al), silicon (Si), and barium (Ba).
